(19) United States
(12) Patent Application Publication
(10) Pub. No.: US 2021/0312851 A1
(43) Pub. Date: Oct. 7, 2021

(54) LED DISPLAY AND METHOD OF OPERATING AN LED DISPLAY

(71) Applicant: OSRAM OLED GmbH, Regensburg (DE)

(72) Inventors: Stefan ILLEK, Donaustauf (DE); Hubert HALBRITTER, Dietfurt (DE); Korbinian PERZLMAIER, Regensburg (DE)

(21) Appl. No.: 17/264,706

(22) PCT Filed: Sep. 9, 2019
(86) PCT No.: PCT/EP2019/073974

§ 371 Date: Jan. 29, 2021

(30) Foreign Application Priority Data
Sep. 14, 2018 (DE) 10 2018 122 545.8

(51) Int. Cl. G09G 3/20; G09G 3/3233

(52) U.S. Cl. CPC G09G 3/2003; G09G 3/3233; G09G 2300/0443; G09G 2300/0452; G09G 2320/0233

(57) ABSTRACT

An LED display having a plurality of pixels is described. The pixels each include at least one inorganic LED and at least one organic LED. Furthermore, a method of operating the LED display is specified.

The invention relates to an LED display and a method of operating the LED display.

This patent application claims priority of German patent application 10 2018 122 545.8, the disclosure content of which is hereby incorporated by reference.

One requirement for displays used, for example, in automotive applications or mobile devices is a high-contrast representation in various lighting situations. To this end, it is desirable for the display to comprise a large number of possible brightness levels both at low brightness levels and at high brightness levels, or in other words a high dynamic range.

An object to be solved is thus to specify a display that is characterized in particular by an improved dynamic range and a high maximum brightness. Furthermore, a suitable method of operating such a display is to be specified.

These objects are solved by an LED display and a method of operating the LED display according to the independent patent claims. Advantageous embodiments and further refinements of the invention are the subject of the dependent claims.

According to at least one embodiment, the LED display comprises a plurality of pixels, wherein the pixels each comprise at least one inorganic LED and at least one organic LED. By arranging at least one inorganic LED and at least one organic LED in each case in the pixels, a very high dynamic range can advantageously be realized with simultaneously high efficiency. In the LED display, for example, the inorganic LEDs of the pixels are operated at high brightness levels, and the organic LEDs of the pixels are operated at low brightness levels, in particular during nighttime operation of the display. In the LED display, the advantages of inorganic LEDs of being able to achieve very high brightness levels are thus combined with the advantages of organic LEDs, which can be dimmed well at low brightness levels and comprise a high contrast.

According to at least one embodiment, the LED display comprises a control device configured to control the brightness of the pixels at least temporarily by pulse width modulation. In pulse width modulation, the inorganic LEDs and/or the organic LEDs of the pixels are operated at constant amplitude of the current intensity with pulses, in particular with square-wave pulses, whose duty cycle is modulated at a fixed frequency, that is, the width of the square-wave pulses is modulated according to the desired brightness. Pulse width modulation can be used in particular to control the brightness of the pixels at high brightness levels.

In a preferred embodiment, the control device is configured to control the brightness of the inorganic LED of the pixels at least temporarily by pulse width modulation, and to control the brightness of the organic LED of the pixels at least temporarily by controlling the current amplitude. “At least temporarily” can mean in particular that the inorganic LED and the organic LED are not necessarily operated simultaneously, rather temporarily only one operation of the inorganic LED and temporarily only one operation of the organic LED can take place. In the LED display, according to this embodiment, two different ways of controlling the brightness of the pixels are combined in an advantageous manner. In particular, the combination of the two different techniques enables an increase in the dynamic range of the LED display. For example, at low brightness levels, the organic LED of the pixels can be regulated by regulating the current amplitude, that is, by so-called analog current dimming. At higher brightness levels, the regulation of the brightness of the inorganic LED of the pixels can be performed by pulse width modulation.

According to at least one embodiment, the control device is configured to operate only the organic LED of the pixels in a first brightness range, and to operate only the inorganic LED of the pixels in a second brightness range, which comprises greater brightness levels than the first brightness range. In this embodiment, the organic LED in the first brightness range is preferably operated by controlling the current amplitude, and the inorganic LED in the second brightness range is operated by pulse width modulation. Alternatively, it is possible that both the organic LED and the inorganic LED are operated by controlling the current amplitude. It is possible, but not mandatory, that the first brightness range and the second brightness range do not overlap with each other. In this case, only the organic LED or only the inorganic LED of the pixels is operated in each case depending on the brightness. In this embodiment, the second brightness range advantageously directly adjoins the first brightness range.

In a further configuration, the control device is configured to operate both the organic LED of the pixels and the inorganic LED of the pixels in a transition range comprising brightness levels between the first brightness range and the second brightness range. In this embodiment, a mixed operation is performed in the transition range in which both the organic LED and the inorganic LED of the pixels are operated.

According to a preferred configuration, the brightness of the pixels is controllable in a dynamic range of at least 2ⁿ-1 brightness levels, wherein n>20. In other words, in this configuration, the LED display has a dynamic range of at least 20 bits. In further preferred configurations, the dynamic range may be at least 22 bits, at least 24 bits, or even at least 26 bits. Such a high dynamic range would not be possible with a conventional LED display comprising, for example, only inorganic LEDs or only organic LEDs, according to the current state of the art. The combination of the advantages of both technologies proposed herein by using at least one organic LED and at least one inorganic LED in each of the pixels of the LED display makes such a high dynamic range possible.

According to at least one embodiment, the inorganic LED and the organic LED are arranged side by side in the pixels. In this case, it is avoided that the organic LED is transilluminated by the inorganic LED or, conversely, that the inorganic LED is transilluminated by the organic LED.

According to at least one further embodiment, the inorganic LED and the organic LED are arranged one above the other in the pixels. This arrangement enables, in particular, a particularly space-saving arranging of the pixels, so that a comparatively small pixel pitch can be achieved.

A method of operating an LED display comprising a plurality of pixels is further specified, wherein the pixels each comprise at least one inorganic LED and at least one organic LED, and wherein a brightness of the pixels is controlled at least temporarily by pulse width modulation and at least temporarily by a control of the current amplitude. Advantageous embodiments of the method and advantages resulting therefrom result inter alia from the previous description of the LED display, so that they will not be fully explained again here.

In a preferred embodiment of the method, the brightness of the inorganic LED of the pixels is controlled at least temporarily by pulse width modulation, wherein the brightness of the organic LED of the pixels is controlled at least temporarily by controlling the current amplitude. Alternatively or additionally, the method may provide an operating mode in which both the organic LED and the inorganic LED are operated by controlling the current amplitude. Preferably, only the organic LED of the pixels or only the inorganic LED of the pixels is operated at least temporarily. In particular, it can be provided that only the organic LED of the pixels is operated in a first brightness range, and only the inorganic LED of the pixels is operated in a second brightness range, which comprises greater brightness levels than the first brightness range. In one configuration of the method, both the organic LED of the pixels and the inorganic LED of the pixels are operated in a transition range comprising brightness levels between the first brightness range and the second brightness range.

According to an advantageous embodiment of the method, the brightness of the pixels comprises a dynamic range with at least 2ⁿ-1 brightness levels, wherein n≥20, preferably n 22, n≥24 or even n≥26. In other words, the dynamic range is at least 20 bits, at least 22 bits, at least 24 bits, or even at least 26 bits. For example, the ratio of the minimum adjustable brightness to the maximum adjustable brightness is 1:67,108,863 for n=26.

In a preferred configuration, the brightness of the inorganic LED of the pixels and/or the organic LED of the pixels comprises a dynamic range with at least 2ⁿ-1 brightness levels, wherein n≥10. In further preferred embodiments, n≥12 or even n≥18. In other words, the dynamic range of the inorganic LED and/or the organic LED is at least 10 bits, preferably at least 12 bits or even at least 18 bits. Particularly preferably, both the inorganic LED and the organic LED each comprise a dynamic range of at least 10 bits or at least 12 bits or even at least 18 bits. For example, if the dynamic range of the pixels as a whole comprises at least 26 bits, this can be realized by the organic LED comprising a dynamic range of at least 18 bits and the inorganic LED comprising a dynamic range of at least 18 bits, wherein the brightness levels overlap with each other in a range of 10 bits.

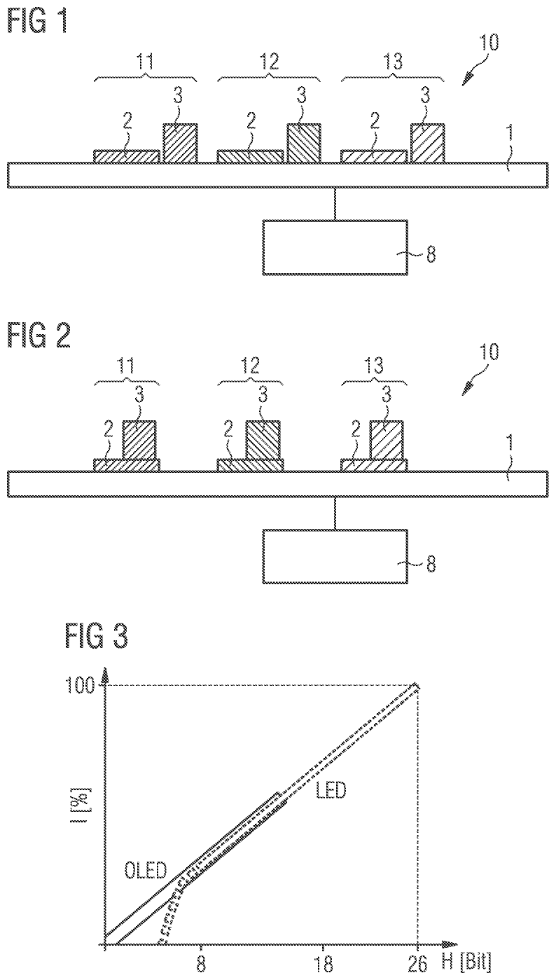

Further advantageous configurations of the LED display and of the method of operating it will be apparent from the following description of various examples in connection with FIGS. 1 to 12.

In the FIGURES

FIG. 1 shows a schematic representation of an LED display according to a first example,

FIG. 2 shows a schematic representation of an LED display according to a second example,

FIG. 3 shows the dynamic range of the pixels as a function of the relative brightness, and

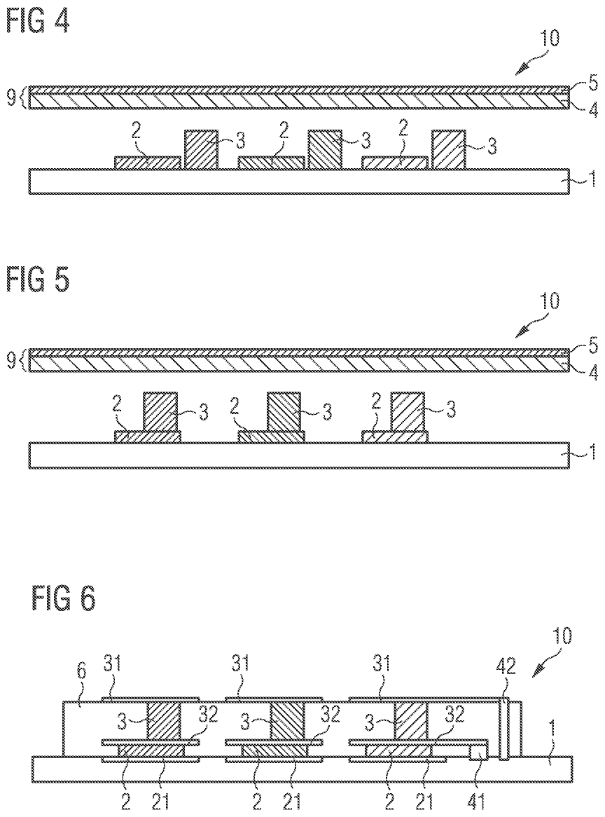

FIG. 4 shows a schematic representation of an LED display according to a third example,

FIG. 5 shows a schematic representation of an LED display according to a fourth example,

FIG. 6 shows a schematic representation of an LED display according to a fifth example,

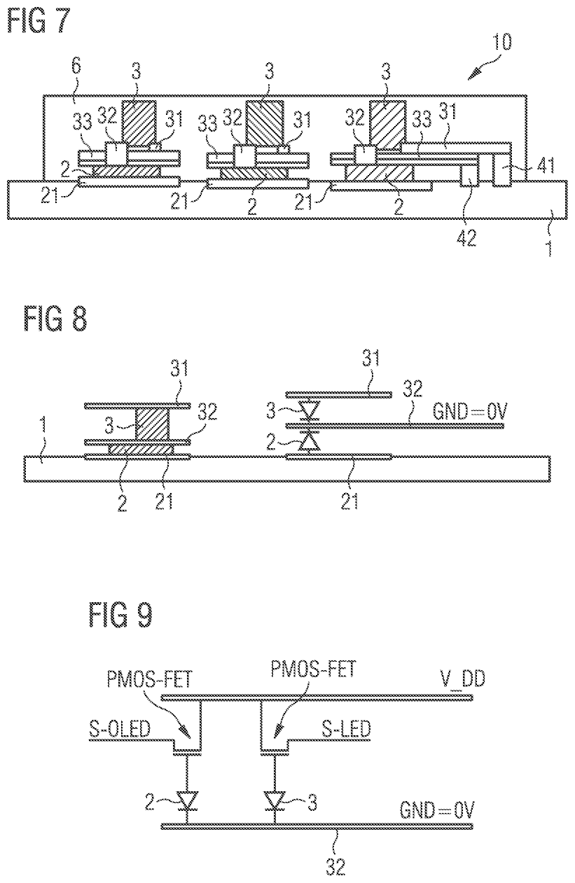

FIG. 7 shows a schematic representation of an LED display according to a sixth example,

FIG. 8 shows a schematic representation of an LED display according to a seventh example,

FIG. 9 shows a schematic representation of an LED display according to an eighth example,

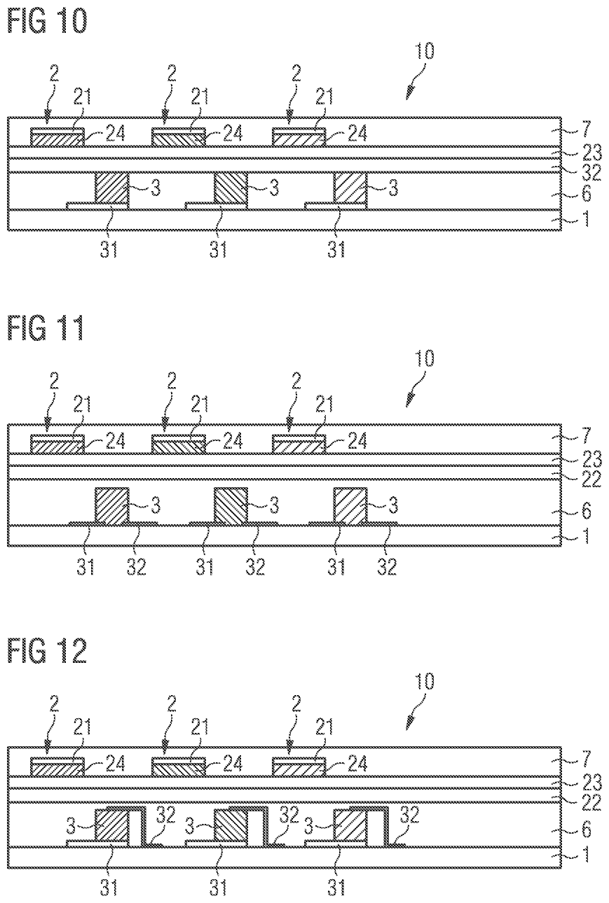

FIG. 10 shows a schematic representation of an LED display according to a ninth example,

FIG. 11 shows a schematic representation of an LED display according to a tenth example, and

FIG. 12 shows a schematic representation of an LED display according to an eleventh example.

Elements that are the same or have the same effect are marked with the same reference signs in the figures. The sizes of the elements shown, as well as the size ratios of the elements to each other, are not to be considered to be to scale; rather, individual elements may be shown exaggeratedly large for clarification.

FIG. 1 schematically illustrates a first example of an LED display 10. The LED display 10 comprises a plurality of pixels 11, 12, 13, wherein only three pixels 11, 12, 13 are shown here and in the further figures to simplify the illustration. The LED display 10 may comprise a plurality of such pixels, for example, more than 100,000 pixels or more than 1 million pixels. In the LED display 10, each pixel 11, 12, 13 comprises at least one organic LED 2 and at least one inorganic LED 3. The internal structure of the organic LED 2 and the inorganic LED 3 are not shown in detail in FIG. 1.

The organic LED 2 comprises in particular an active layer suitable for the emission of light, which is formed with an organic material suitable for the emission of light. The organic LED 2 may additionally comprise, for example, an electron injection layer, an electron transport layer, a hole injection layer, a hole transport layer, and a first and a second electrode.

The inorganic LED 3 also comprises an active layer suitable for emitting light, which is formed with an inorganic semiconductor material suitable for emitting light. The active layer is typically arranged between an n-type semiconductor region and a p-type semiconductor region. In particular, the inorganic LED is based on a III-V semiconductor material. The semiconductor material is, for example, a nitride compound semiconductor material such as AlₙInₗ₋ₙ₋ₘGaₘN or a phosphide compound semiconductor material such as AlₙInₗ₋ₙ₋ₘGaₘP or also an arsenide compound semiconductor material such as AlₙInₗ₋ₙ₋ₘGaₘAs or such as AlₙGaₘInₗ₋ₙ₋ₘAsₖPₗ₋ₖ, wherein in each case 0≤n≤1, 0≤m≤1 and n+m≤1 as well as 0≤k<1. Preferably, for at least one layer or for all layers of the semiconductor layer sequence, 0<n≤0.8, 0.4≤m<1 and n+m≤0.95 as well as 0<k≤0.5 apply. In this context, the semiconductor layer sequence may comprise dopants as well as additional constituents. However, for the sake of simplicity, only the essential constituents of the crystal lattice of the semiconductor layer sequence, i.e. Al, As, Ga, In, N or P, are specified, even if these may be partially replaced and/or supplemented by small amounts of additional substances.

The semiconductor material is selected in particular according to the emission wavelength to be realized. It is possible that each pixel of the display comprises several subpixels for light emission of different colors. In this case, each subpixel comprises at least one organic LED 2 and at least one inorganic LED 3 for emission of the respective color. The LED display 10 is then a multicolor LED display 10. The LED display 10 may in particular be an RGB display. In this case, the pixels comprise at least three sub-pixels of the colors red, green and blue, wherein each sub-pixel comprises an organic LED 2 and an inorganic LED 3. For example, the three pixels 11, 12, 13 shown in FIG. 1 may be subpixels of an RGB color pixel, wherein for example pixel 11 is a red subpixel, pixel 12 is a green subpixel, and pixel 13 is a blue subpixel.

The LED display 10 comprises a carrier 1 via which the LEDs 2, 3 are electrically contacted. In particular, the carrier 1 may be a printed circuit board comprising conductor tracks for supplying current to the LEDs 2, 3. The carrier 1 may be connected to a control device 8 suitable for controlling the LEDs 2, 3. It is possible that the control device 8 or parts thereof are integrated in the carrier 1. Depending on the emission direction of the LED display, the carrier 1 may be opaque or translucent. In the case of a front side emitting LED display, for example, the carrier 1 is formed of an opaque material.

In the case of a back side emitting LED display, the carrier 1 is formed of a transparent material such as a glass. In this case, conductor tracks arranged in or on the carrier also advantageously comprise a transparent material such as a transparent conductive oxide (TCO).

FIG. 2 shows another exemplary embodiment of the LED display, in which the organic LED 2 and the inorganic LED 3 of the pixels 11, 12, 13 are each arranged one above the other. This embodiment has in particular the advantage that a comparatively small pixel pitch can be achieved. In particular, it is also possible for the organic LED 2 and the inorganic LED 3 to each comprise a common electrical contact. Concrete embodiments will be explained in more detail in subsequent exemplary embodiments.

The LED display 10 described herein, in which the pixels 11, 12, 13 each comprise an organic LED 2 and an inorganic LED 3, has in particular the advantage that a high brightness dynamic range can be achieved in this way. FIG. 3 shows an example of the relative brightness I (in percent) as a function of the brightness information (in bits) in the dynamic range of the display. In the example shown, the LED display comprises a dynamic range of at least 26 bits. Deviating from FIG. 3, the relative brightness can also depend non-linearly on the brightness information.

An LED display that comprises a dynamic range of n bits may have 2ⁿ-1 non-zero brightness levels. For example, an LED display with a dynamic range of 1 bit comprises only 2¹-1, i.e. only one non-zero brightness level, meaning that the LED is either off or has a brightness of 100%. Accordingly, an LED display with a dynamic range of 2 bits comprises 2²-1 non-zero brightness levels, i.e. three brightness levels. In the example shown with a dynamic range of 26 bits, the display comprises 2²⁶-1 brightness levels, i.e. 67,108,863 brightness levels. The ratio of the smallest non-zero brightness to the largest non-zero brightness is therefore 1:67,108,863.

This extremely high dynamic range is realized in the LED display described herein by combining at least one organic LED 2 and at least one inorganic LED 3 in each of the pixels. The total dynamic range of 26 bits is distributed between brightness levels achieved with the organic LED and brightness levels realized with the inorganic LED. For example, the organic LED covers a first region of low brightness levels that has a dynamic range of 18 bits (labeled OLED in FIG. 3). Further, in the example, the inorganic LED also covers a dynamic range of 18 bits (labeled LED in FIG. 3), wherein the inorganic LED operates in a second brightness range that includes higher brightness levels than the first brightness range. For example, the first brightness range of the LED display may be for nighttime operation and the second brightness range may be for daytime operation.

In the example shown, the first brightness range and the second brightness range overlap with each other in a transition range. In this transition range, which in the example comprises a dynamic range of 10 bits, the brightness values can be realized by the organic LED and/or the inorganic LED. It is possible, but not absolutely necessary, for the organic LED and the inorganic LED to be operated simultaneously in this transition range. Alternatively, it is also possible that such a transition range is omitted in order to avoid mixed operation of the organic LED and the inorganic LED.

The organic LED is preferably controlled at low brightness levels by pure current dimming, that is, by controlling the current amplitude. In this way, for example, a dynamic range of about 12 bits can be achieved. In addition, pulse width modulation can be provided for the organic LED, with which, for example, a further dynamic range of about 6 bits can be achieved. Combining the current dimming and the pulse width modulation thus results in the dynamic range of 18 bits realized by the organic LED. The operation of the organic LED at low brightness levels by means of current dimming is advantageous, since at low brightness levels it is difficult to operate the inorganic LED by means of pulse width modulation (indicated by the dashed line in FIG. 3), since the pulse widths would have to be very short for pulse width modulation.

It is possible that the inorganic LED is controlled only by pulse width modulation. With a frame rate of 100 Hz, i.e. a period duration of 10 ms, a dynamic range of 18 bits results in a shortest pulse duration of 38 ns. Alternatively, it is also possible for the inorganic LED to be controlled by both pulse width modulation and current dimming. This can be realized, for example, in such a way that a dynamic range of 11 bits is realized by pulse width modulation and another dynamic range of 7 bits is realized by current dimming. If a dynamic range of 11 bits is to be realized by pulse width modulation with a period duration of 10 ms, this results in a shortest pulse duration of 5 μs, for example.

FIGS. 4 and 5 show variations of the examples in FIGS. 1 and 2. FIG. 4 shows the LED display 10 according to FIG. 1, in which the organic LEDs 2 and inorganic LEDs are arranged side by side, and wherein an optical element 9 is arranged above the LED display 10. The optical element 9 may be provided in particular to suppress unwanted reflections at the LED display 10. In the examples shown, the optical element 9 is a combination of a λ/4 plate 4 and a linear polarizer 5 arranged one above the other to reduce reflections. However, other embodiments of the optical element 9 are alternatively possible.

In a corresponding manner, FIG. 5 shows the LED display 10 according to FIG. 2, wherein the organic LEDs 2 and inorganic LEDs 3 are arranged one above the other, and wherein an optical element 9 is arranged above the LED display 10, comprising a λ/4-plate 4 and a linear polarizer 5 to suppress unwanted reflections at the LED display 10. In each of FIGS. 4 and 5, the LED display 10 is a display emitting toward the front, i.e., the side facing away from the carrier 1. Alternatively, the LED display 10 may be a display emitting towards the back side, i.e. the radiation is emitted through the carrier 1. The carrier 1 may be connected to a control device, as in the previous examples, which is not shown here or in the following examples for simplicity.

FIG. 6 illustrates another example of the LED display, in which the organic LED 2 and the inorganic LED 3 are arranged one above the other in the pixels. The LED display 10 may comprise an encapsulation 6 in which the organic LEDs 2 and inorganic LEDs 3 are embedded. The encapsulation 6 protects the LED display 10 in particular from external influences. The encapsulation 6 can be designed as a spin-on-glass, for example.

The inorganic LED 3 comprises a first electrode 31 and a second electrode 32, respectively. The organic LED 2 comprises a first electrode 21 and a second electrode 32, respectively, wherein the second electrode 32 is arranged between the organic LED 2 and the inorganic LED 3 and is formed as a common electrode for the organic LED 2 and the inorganic LED 3. In the example, the first electrode 21 of the organic LED 2 is respectively arranged directly on the carrier 1. The first electrode 31 of the inorganic LED 3 and the common second electrode 32 may be connected to the carrier 1, for example, by means of contact feed throughs 41, 42 which are guided through the encapsulation 6. It is possible that the first electrode 31 or the second electrode 32 are connected to each other for several pixels or subpixels arranged next to each other.

The LED display 10 according to FIG. 6 may be a front side emitting LED display or a back side emitting LED display. In the case of a front side emitting LED display, the first electrode 31 of the inorganic LEDs 3 and the common second electrode 32 of the organic LEDs 2 and inorganic LEDs 3 are advantageously each transparent electrodes. The transparent electrodes may comprise, for example, a transparent conductive oxide such as ITO. The back side first electrode 21 of the organic LEDs 2 is preferably designed as a metal contact in the case of the front side emitting LED display, in order to reflect radiation emitted in the direction of the carrier 1.

Alternatively, it is possible that the LED display 10 according to FIG. 6 is configured as a back side emitting LED display. In this configuration, the first electrodes 21 of the organic LEDs 2 and the common electrodes 32 of the organic LEDs 2 and inorganic LEDs 3 are advantageously designed as transparent electrodes comprising, for example, ITO. In this configuration, the front-side first electrodes 31 of the inorganic LEDs 3 are preferably designed as metal contacts in order to reflect emitted radiation in the direction of the radiation exit surface. In this configuration, the carrier 1 and any control electronics contained therein are at least substantially transparent. The carrier 1 can comprise, for example, control electronics based on IGZO (indium gallium zinc oxide) or LTPS (low temperature poly-silicon).

The further example of the LED display shown in FIG. 7 differs from the previous example in that the inorganic LEDs 3 are each designed as a flip chip. In this configuration, both electrodes 31, 32 of the inorganic LED 3 are each arranged on the back side thereof, i.e. on a side facing the organic LED 2. The second electrode 32 may be implemented as a common electrode with the organic LEDs 2, as in the previous exemplary embodiment. The electrodes 31, 32 may be connected to the carrier 1 by means of contact feed throughs 41, 42 extending through the encapsulation 6. The electrodes 31, 32 are insulated from each other by a transparent electrically insulating layer 33.

In accordance with the example of FIG. 6, the LED display 10 of FIG. 7 can also be either a front side emitting LED display or a back side emitting LED display. In the case of the front-emitting LED display, the first electrodes 21 of the organic LEDs 2 are each designed as reflective metal contacts. In contrast, the first electrode 31 of the inorganic LEDs 3 and the common electrode 32 are advantageously each designed as transparent, for example as transparent conductive oxide.

In the case of a back side emitting LED display, the first electrodes 21 of the organic LEDs 2 facing the carrier 1 are advantageously each implemented as transparent electrodes. Advantageously, the organic LEDs 2 are each transparent so that the inorganic LEDs 3 can radiate downward through the organic LEDs 2.

In the following FIGS. 8 and 9, an exemplary arrangement of the electrodes 31, 32, 21 and their electrical circuitry is shown schematically. As can be seen in the left half of

FIG. 8, the inorganic LED comprises a first electrode 31 and a second electrode 32, wherein the first electrode 31 is arranged, for example, on the upper side of the inorganic LED 3 and the second electrode 32 is arranged, for example, on the underside of the inorganic LED 3 facing the organic LED 2. The organic LED 2 comprises a first electrode 21 facing the carrier 1 and is connected at the upper side to the second electrode 32 of the inorganic LED 3, wherein the second electrode 32 acts as a common cathode for both the organic LED 2 and the inorganic LED 3.

As can be seen in the schematic circuit diagram on the right side of FIG. 8, the common cathode 32 is connected to ground potential, for example, wherein the anode electrodes 21, 31 are each connected to a PMOS (p-channel metal oxide semiconductor) and are driven by a signal in this way.

FIG. 9 shows the electrical control schematically in a circuit diagram. The common cathode 32 of the organic LED 2 and the inorganic LED 3 are each connected to ground potential (GND=0V). A supply voltage V_DD can be applied to each of the anodes. The control is performed, for example, via a PMOS field-effect transistor switched 3 with a signal S-OLED for the organic LED 2 and a signal S-LED for the inorganic LED.

In the following FIGS. 10, 11 and 12, three examples of the LED display are shown in which the organic light-emitting diode 2 is arranged above the inorganic light-emitting diode 3 in each case as viewed from the carrier 1.

In the exemplary embodiment of FIG. 10, the LED display 10 comprises a carrier 1, which may comprise a glass, for example. The inorganic LEDs 3 each comprise a first electrode 31 facing the carrier 1. The inorganic LEDs 3 are surrounded by an encapsulation 6, which comprises, for example, a spin-on-glass. On the upper side facing away from the carrier 1, the inorganic LEDs 3 comprise a common anode 32, which is advantageously a layer of a transparent conductive oxide, such as ITO. In particular, the second electrode 32 is transparent. Furthermore, the second electrode 32 also serves as an anode for the organic LEDs 2, which are arranged above the inorganic LEDs 3. The organic LEDs 2 may comprise a common hole transport layer 23 deposited on the second electrode 32. The light-emitting active layers 24 of the organic LEDs 2 are deposited on the hole transport layer 23 in a structured form, i.e. as separate layers for the individual organic LEDs 2. The first electrodes 21 of the organic LEDs 2, which in particular form the cathodes, are arranged above the active layers. For protection against external influences, a further encapsulation 7 is advantageously applied to the organic LEDs 2.

The LED display 10 according to FIG. 11 differs from the previous example in that both the first electrode 31 and the second electrode 32 of the inorganic LEDs 3 are arranged on an underside of the inorganic LEDs 3 facing the carrier 1. In particular, the inorganic LEDs 3 are formed as flip chips. Furthermore, in this example, the inorganic LEDs 3 are covered on their upper side by the encapsulation 6, in particular a spin-on-glass.

The common second electrode 22 of the organic LEDs 2 is arranged on the encapsulation 6 and has no electrical contact to the inorganic LEDs 3. As in the previous exemplary embodiment, a hole transport layer 23 is arranged on the second electrode 22 of the organic LEDs 2, on which the light-emitting organic layers 24 as well as the first electrodes 21 representing the cathodes are applied. The organic LEDs 2 are again protected against external influences by an encapsulation 7.

In the further example of an LED display according to FIG. 12, the inorganic LEDs 3 comprise, as in the previous exemplary embodiment, a first electrode 31 and a second electrode 32, respectively, which comprise no electrical connection to the electrodes 21, 22 of the organic LEDs 2. Unlike the previous exemplary embodiment, the inorganic LEDs 3 are configured as vertical LEDs in which the first electrode 31 faces the carrier 1, and wherein the second electrode 32 is arranged on the upper side facing away from the carrier. The second electrode 32 on the upper side of the inorganic LEDs can be connected to the carrier 1 and any control electronics contained therein by means of an electrically conductive connection which is passed through the encapsulation 6. The encapsulation 6 of the inorganic LEDs 3 forms an electrically insulating surface on which the second electrode 22 of the organic LEDs 2 is arranged. The structure and contacting of the organic LEDs 2 corresponds to the previous exemplary embodiment. In particular, a hole transport layer 23 is arranged on the second electrode 22, which may in particular be an ITO layer, on which the light-emitting organic layers 24 and the first electrodes 21 are arranged. Furthermore, the organic LEDs 2 are arranged in a further encapsulation 7 as in the previous exemplary embodiments.

The invention is not restricted by the description based on the exemplary embodiments. Rather, the invention encompasses any new feature as well as any combination of features, which in particular includes any combination of features in the patent claims, even if this feature or combination itself is not explicitly specified in the patent claims or exemplary embodiments.

### LIST OF REFERENCE SIGNS

1 carrier

2 organic LED

3 inorganic LED

4 λ/4-plate

5 linear polarizer

6 encapsulation

7 encapsulation

8 control device

9 optical element

10 LED display

11 pixel

12 pixel

13 pixel

21 first electrode

22 second electrode

23 hole transport layer

24 organic active layer

31 first electrode

32 second electrode

33 electrically insulating layer

41 contact feed through

42 contact feed through

1. An LED display having a plurality of pixels, wherein the pixels each comprise at least one inorganic LED and at least one organic LED.

2. The LED display according to claim 1, wherein the LED display comprises a control device configured to control a brightness of the pixels at least temporarily by pulse width modulation.

3. The LED display according to claim 2, wherein the control device is configured to control the brightness of the inorganic LED of the pixels at least temporarily by pulse width modulation, and to control the brightness of the organic LED of the pixels at least temporarily by controlling the current amplitude.

4. The LED display according to claim 1, wherein the control device is configured to operate only the organic LED of the pixels in a first brightness range, and to operate only the inorganic LED of the pixels in a second brightness range comprising higher brightness levels than the first brightness range.

5. The LED display according to claim 1, wherein the control device is configured to operate both the organic LED of the pixels and the inorganic LED of the pixels in a transition range comprising brightness levels between the first and the second brightness range.

6. The LED display according to claim 1, wherein the brightness of the pixels is controllable in a dynamic range with at least 2ⁿ-1 brightness levels, where n>20.

7. The LED display according to claim 1, wherein the inorganic LED and the organic LED are arranged side by side in the pixels.

8. The LED display according to claim 1, wherein the inorganic LED and the organic LED are arranged one above the other in the pixels.

9. A method of operating an LED display comprising a plurality of pixels, wherein the pixels each comprise at least one inorganic LED and one organic LED, and wherein a brightness of the pixels is controlled at least temporarily by pulse width modulation and at least temporarily by a control of current amplitude.

10. The method of operating an LED display according to claim 9, wherein the brightness of the inorganic LED of the pixels is controlled at least at times by pulse width modulation, the brightness of the organic LED of the pixels being controlled at least at times by a control of the current intensity amplitude.

11. The method of operating an LED display according to claim 9,
wherein at least temporarily only the organic LED of the pixels or only the inorganic LED of the pixels is operated.

12. The method of operating an LED display according to claim 9,
wherein only the organic LED of the pixels is operated in a first brightness range, and only the inorganic LED of the pixels is operated in a second brightness range which comprises greater brightness levels than the first brightness range.

13. The method of operating an LED display according to claim 9,
wherein in a transition range comprising brightness levels between the first and second brightness ranges, both the organic LED of the pixels and the inorganic LED of the pixels are operated.

14. The method of operating an LED display according to claim 9,
wherein the brightness of the pixels comprises a dynamic range with at least 2ⁿ-1 brightness levels, where n≥20.

15. The method of operating an LED display according to claim 9,
wherein the brightness of the inorganic LED of the pixels and/or the organic LED of the pixels comprises a dynamic range with at least 2ⁿ-1 brightness levels, wherein n≥10.

16. The method of operating an LED display according to claim 9, wherein each pixel of the display comprises several subpixels for light emission of different colors and wherein each subpixel comprises at least one organic LED and at least one inorganic LED for emission of the respective color.

17. An LED display having a plurality of pixels, wherein each pixel of the display comprises several subpixels for light emission of different colors and wherein each subpixel comprises at least one organic LED and at least one inorganic LED for emission of the respective color.
